(19) United States
(12) Patent Application Publication
(10) Pub. No.: US 2013/0255634 A1
(43) Pub. Date: Oct. 3, 2013

(54) Barrier System for Removing Water and Solid Contaminents from Fuel

(71) Applicant: John Edgar Scragg, Durban (ZA)

(72) Inventor: John Edgar Scragg, Durban (ZA)

(21) Appl. No.: 13/992,543

(22) PCT Filed: Dec. 6, 2011
(86) PCT No.: PCT/IB2011/055486

§ 371 Date: Jun. 7, 2013

(30) Foreign Application Priority Data
Dec. 7, 2010 (ZA) 2010/08771

(51) Int. Cl. B01D 35/00

(52) U.S. Cl. CPC B01D 35/005
USPC 123/445; 210/435; 210/85; 210/416.4; 210/767

(57) ABSTRACT

A barrier system is disclosed which is fitted to the filler opening (12) of a fuel tank (10). The system comprises an outer sleeve (34) in the form of a coil spring (36) and lining (38) which is of a material that permits fuel to flow through it but which retains water and solid contaminants A valve (52, 54) is provided at the lower of the sleeve (34) for enabling accumulated water and solid contaminents to be drained from the sleeve (34).

### FIELD OF THE INVENTION

THIS INVENTION relates to a barrier system for removing water and solid contaminants from fuel before it is fed to an engine.

### BACKGROUND TO THE INVENTION

The internal combustion engine is susceptible to damage from water and contaminants in the fuel. Diesel engines are particularly prone to damage and it seems the more technologically advanced they become the more they are prone to this particular damage. One current solution is to place a filter in the fuel line between the fuel tank and the engine. However, the extremely high flow rates in what are called common-rail diesel engines cause many problems. In these systems most of the fuel pumped through the fuel line is returned to the tank so the in-line filters filter the same fuel many time over. These in-line fuel filters are not fully able to cope with the high flow rates and the volumes of fuel that pass through them.

The present invention provides a means of protecting an engine from the water damage which may arise from filling the engine's fuel tank from a contaminated fuel source.

### BRIEF DESCRIPTION OF THE INVENTION

According to one aspect of the present invention there is provided a barrier unit for fitting to the filler opening of a fuel tank for preventing water and solid contaminants from entering the fuel tank with the fuel, the barrier unit comprising a liner of a material which permits fuel to pass through it but retains water and solid contaminants, the liner being closed at its lower end and open at its upper end to form an inlet to the liner so that fuel being pumped to the tank enters the liner at its upper end, there being a perforated cylindrical support which sheaths the liner and prevents the liner being burst by the pressure of the fuel flowing into it.

Preferably there is, at the lower end of the liner, valve means for enabling accumulated water to be drained from the unit.

Said support can be in the form of a coil spring with gaps between the turns of the spring, the gaps forming said perforations.

Said sleeve preferably comprises a coil spring with a removable lining of filter material in it.

The lining can be a polymer film or resin impregnated paper.

According to a further aspect of the present invention there is provided a fuel tank having a filler opening and a storage space for fuel, there being a water and solid contaminants retaining barrier through which fuel entering via the filler opening flows before reaching said storage space.

Said barrier is preferably in the form of a flexible sleeve which is closed at its lower end, the sleeve being secured in said filler opening and hanging down in said storage space. In this form barrier can comprise a sleeve extending from said filler opening downwards to the bottom of the tank, there being a drain opening in the bottom of the tank and a valve in the drain opening, the interior of the sleeve being in communication with said drain opening so that, when the valve is opened, water which has accumulated at the bottom of the sleeve drains out.

Said valve can be a manually operable tap which is accessible from the underside of the tank. In another constructional form said valve comprises a valve element which is pressed against a valve seat by a spring, there being a pull cord which extends upwardly from said valve element, there being a pull ring for enabling an upward pull to be exerted on the valve element to lift the valve element from said seat against the action of the spring.

Preferably said barrier comprises a perforated outer support and a lining of filter material which can be removed from said support.

A sensor can be provided for detecting a water build up at the lower end of said sleeve together with an alarm which is activated upon said sensor detecting a water build up.

To increase the flow rate means for creating a sub-atmospheric pressure in the fuel tank can be included thereby to draw fuel through the barrier unit.

According to another aspect of the present invention there is provided a method of removing water and contaminants from fuel which comprises placing a water and solids contaminants barrier between a filler opening of a fuel tank and the storage space of the fuel tank so that the fuel entering the tank through the filler opening passes through the barrier before reaching said storage space.

According to a still further aspect of the present invention there is provided a method of filling a fuel tank which has a fuel inlet, a fuel storage space and a fuel outlet from said space connected by a fuel feed pipe to the fuel injection system of an engine, the method comprising feeding the fuel into said storage space of the tank through a water and contaminant removing barrier which is between said fuel inlet and said storage space.

### BRIEF DESCRIPTION OF THE DRAWINGS

For a better understanding of the present invention, and to show how the same may be carried into effect, reference will now be made, by way of example, to the accompanying drawings in which:

FIG. 1 is a top plan view of a fuel tank;

FIG. 2 is a diagrammatic representation of a barrier system, the portion in the circle being shown to a larger scale in the scrap drawing;

FIG. 3 is a diagrammatic representation of a further barrier system;

FIG. 4 is a diagrammatic representation of another form of barrier system;

FIG. 5 is a diagrammatic representation of a modification of the barrier system of FIG. 4; and

FIG. 6 illustrates a further barrier system configuration.

### DETAILED DESCRIPTION OF THE DRAWINGS

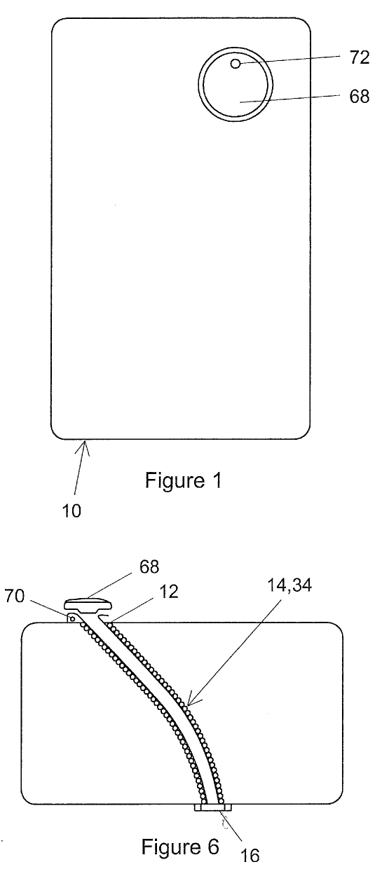

In FIG. 1 reference numeral 10 designates the fuel tank of an engine which can be a petrol or diesel engine.

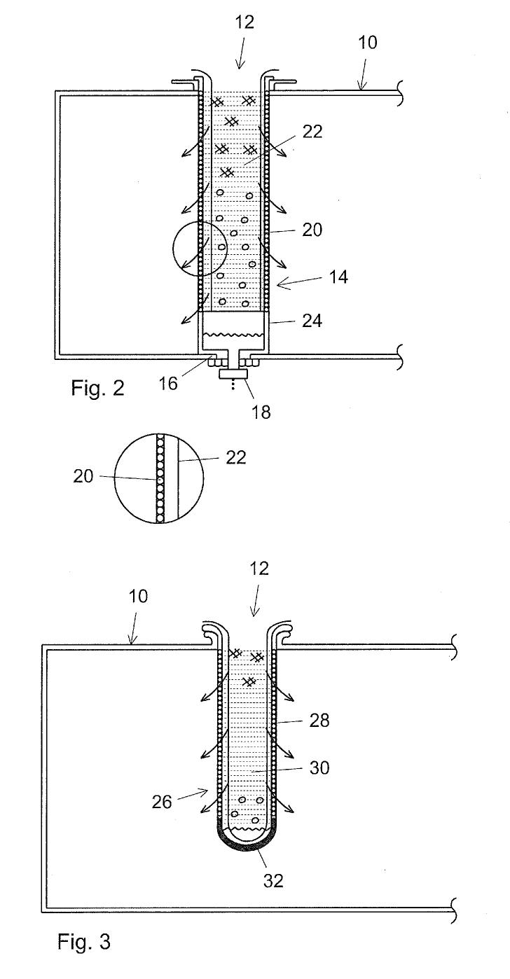

As shown in FIG. 2, the tank 10 has a filler opening 12, there being a sleeve 14 which has its upper end fitted into the opening 12 and its lower end attached to the bottom of the tank 10 in register with a water drain opening 16. There is a tap 18 in the opening 16. The tap is accessible from the underside of the tank 10. In the illustrated form the upper part of the sleeve is constituted by a coil spring 20. There are small gaps between the turns of the coil spring 20. The gaps form perforations. The sleeve 14 further comprises a sheet material lining 22 inside the spring 20. The lower part of the sleeve 14 is in the form of a bowl 24 for receiving water and contaminants that are retained by the lining 22. The bowl 24 can be injection moulded and the end coil of the spring 20 can be embedded in the bowl during moulding.

In a further form the coil spring can be replaced by a perforated metal tube with the lining 22 inside it.

The lining 22 can be permanently secured to the metal sleeve or to the coil spring 20 or can be in the form of a sheath which is fitted into the sleeve and which can be removed if it becomes clogged.

The fuel entering the storage space in the tank 10 from the sleeve 14 is water and solid contaminant free. The retained water sinks to the bottom of the sleeve 14 where it collects in the bowl 24 immediately above the drain opening 16. By opening the tap 18 the collected water can be allowed to flow to waste from the bowl.

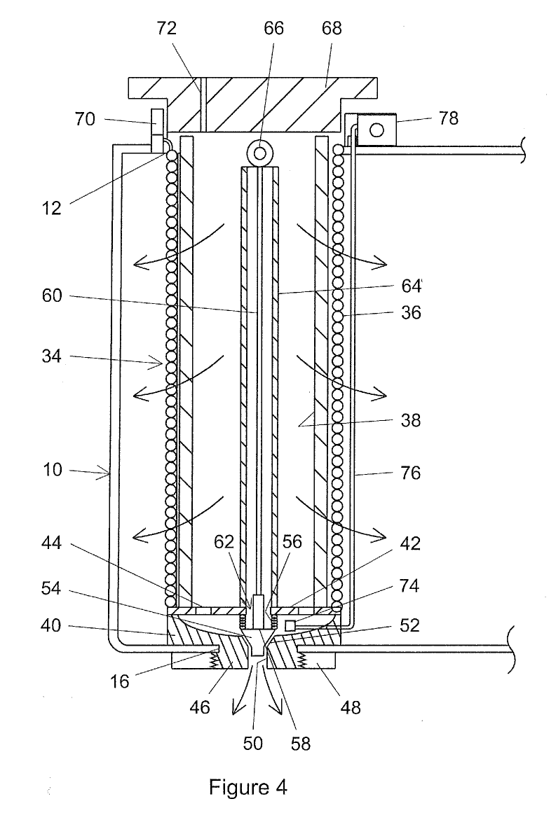

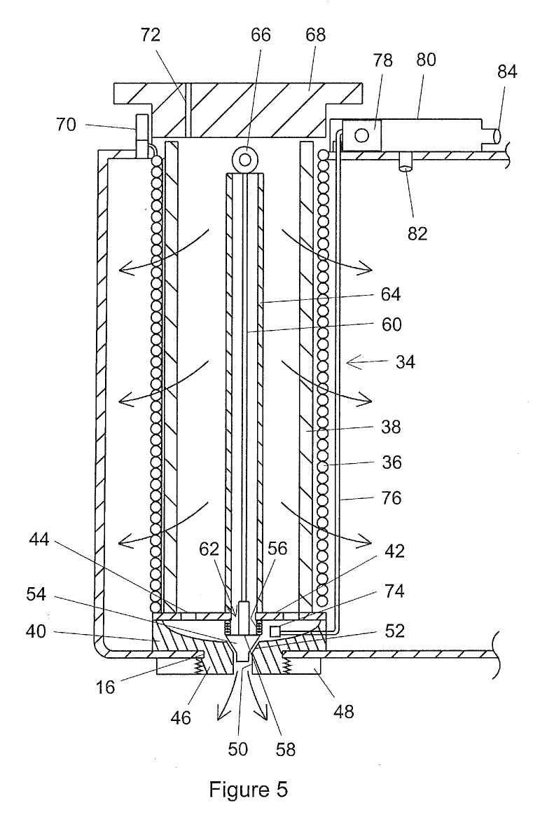

If desired a sensor can be provided which, upon it detecting a predetermined quantity of water in the bowl of the sleeve 14, automatically opens a drain valve for a timed period. The sensor may in an alternative embodiment activate an alarm (visual or audible) which alerts the person using the engine to a water build up. He can then manually operate the tap 18. The second of these modifications is described below with reference to FIGS. 4 and 5.

In the embodiment of FIG. 2 a flexible sleeve 26 is shown which hangs down in the tank 10. The sleeve 26 is constituted by a coil spring 28 having a lining 30 of a material which prevents water and contaminants flowing out of the sleeve with the fuel. The sleeve is inserted into the fuel tank and secured to the filter opening 12. The lower end of the sleeve 26 is closed by a bowl 32.

The fuel flowing in through the opening 12 enters the sleeve 26 and flows through the lining 30. Water and contaminants are retained. Once filling is complete, the sleeve 26 is removed from the tank 10, the water which has collected at the closed lower end of the sleeve in the bowl 32 tipped out and the tube dried for re-use.

Resin impregnated paper is a suitable medium which allows fuel to pass through it but retains water and solid contaminants. Polymer films are also available commercially which will allow fuel to pass but will retain water and solid contaminants.

Removing solid contaminants and water before the fuel reaches the in-line filters between the fuel tank and the engine has the effect of increasing the useful life of such filters.

Turning now to FIG. 4, the barrier system of this Figure has many parts in common with the barrier system of FIG. 2.

The upper part of the sleeve 34 of the barrier system of FIG. 4 is in the form of a coil spring 36 which has a filter material lining 38 inside it. The lower end is constituted by an upwardly open water and solid contaminants collection bowl 40. A closure 42 with holes 44 in it is a press fit into the open mouth of the bowl 40. The underside of the bowl 40 is extended downwardly by an externally threaded spigot 46 which passes through the water drain opening 16 of the tank 10. A nut 48 screwed onto the spigot 46 and tightened against the underside of the tank 10 secures the bowl 40 to the tank 10.

A bore 50 passes through the spigot 46. Within the bore 50 there is a valve seat 52 of conical form.

A conical valve element 54 is pressed against the seat 52 by a coil spring 56. The spring 56 is between the top surface 58 of the valve element 54 and the underside of the closure 42.

A flexible cord 60 is attached to the valve element 54 and extends upwards through a central opening 62 in the closure 42 and upwards through a tube 64 which terminates near the upper end of the sleeve 34.

A pull ring 66 is secured to the upper end of the cord 60 above the tube 64. So that it does not obstruct entry of the filler nozzle, it is desirable that the tube 64, or at least the upper part of it, be offset to one side of the sleeve 34.

The cap, designated 68 in FIGS. 1, 4, 5 and 6, which closes the filler opening 12 of the tank 10 is attached to a ring 70 which is attached to the tank 10 and encircles the opening 12 of the tank 10. The cap 68 has breather opening 72.

A water sensor 74 (FIGS. 4 and 5) is provided in the bowl 40 and a signal wire 76 extends to an alarm 78 fitted to the top of the tank 10. The alarm 78 can include an audible warning such as a piezoelectric sounder and/or an LED for providing visible warning.

The lining 38 is of a material which allows the diesel to flow through at a rate faster than it enters the lining 38 from the filler nozzle (not shown) being used to fill the tank 10.

The barrier system of FIG. 5 is identical to that of FIG. 4 except in that an air extraction unit 80 is fitted to the top of the tank 10. The unit 80 has an inlet 82 which communicates with the tank 10 and an outlet 84 which communicate with the atmosphere. An air pump and an electric motor for driving the pump are provided within the casing of the unit 80. The motor drives the pump so that air is sucked from the inside of the tank and expelled into the atmosphere as filling of the tank 10 proceeds. The electric motor may be replaced by an impeller to which compressed air is fed from the brake system.

It will be understood that it is desirable to provide filter material with very small size pores as this ensures that all but the very smallest solid particles are retained. However, this inevitably results in a slow rate of flow through the filter material. Creating a sub-atmospheric pressure in the storage space of the tank causes fuel to be sucked through the filter material at a faster rate than can be achieved by gravity alone.

The use of the springs 20 and 36 enables the sleeve 14 to be distorted. This is necessary when the filler opening is at an angle to the vertical and the sleeve must be bent to enable it to be aligned with the tank's drain outlet 16. It is also necessary, as shown in FIG. 6, if the filler opening 12 and the drain opening 16 are not vertically one above the other. The configuration of FIG. 6 increases the length of the filter material lining 38. It is also possible to provide a sleeve of spiral form thereby to increase the area of the filter material lining.

The valve element 54 is normally pressed against the seat 52 by the spring 56. When it is desired to drain the bowl 40, the ring 66 is pulled upwardly to lift the element 54 off the seat 52 against the action of the spring 56.

1. A barrier unit for fitting to the filler opening of a fuel tank for preventing water and solid contaminants from entering the fuel tank with the fuel, the barrier unit comprising a liner of a material which permits fuel to pass through it but retains water and solid contaminants, the liner being closed at its lower end and open at its upper end to form an inlet to the liner so that fuel being pumped to the tank enters the liner at its upper end, there being a perforated cylindrical support which sheaths the liner and prevents the liner being burst by the pressure of the fuel flowing into it.

2. A unit as claimed in claim 1, wherein there is, at the lower end of the liner, valve means for enabling accumulated water to be drained from the unit.

3. A unit as claimed in claim 1, wherein said support is in the form of a coil spring with gaps between the turns of the spring, the gaps forming said perforations.

4. A unit as claimed in claim 1, wherein said sleeve comprises a coil spring with a removable lining of filter material in it.

5. A fuel tank as claimed in claim 1, wherein the lining is a polymer film or resin impregnated paper.

6. A fuel tank having a filler opening and a storage space for fuel, there being a water and solid contaminants retaining barrier through which fuel entering via the filler opening flows before reaching said storage space.

7. A fuel tank as claimed in claim 6, wherein the barrier is in the form of a flexible sleeve which is closed at its lower end, the sleeve being secured in said filler opening and hanging down in said storage space.

8. A fuel tank as claimed in claim 6, wherein the barrier is in the form of a sleeve extending from said filler opening downwards to the bottom of the tank, there being a drain opening in the bottom of the tank and a valve in the drain opening, the interior of the sleeve being in communication with said drain opening so that, when the valve is opened, water which has accumulated at the bottom of the sleeve drains out.

9. A fuel tank as claimed in claim 8, wherein said valve is in the form of a manually operable tap which is accessible from the underside of the tank.

10. A fuel tank as claimed in claim 8, wherein said valve comprises a valve element which is pressed against a valve seat by a spring, there being a pull cord which extends upwardly from said valve element, there being a pull ring for enabling an upward pull to be exerted on the valve element to lift the valve element from said seat against the action of the spring.

11. A fuel tank as claimed in claim 6 wherein said barrier comprises a perforated outer support and a lining of filter material which can be removed from said support.

12. A fuel tank as claimed in claim 6 and including a sensor for detecting a water build up at the lower end of said sleeve and an alarm which is activated upon said sensor detecting a water build up.

13. A fuel tank as claimed in claim 6 and including means for creating a sub-atmospheric pressure in the fuel tank thereby to draw fuel through the barrier unit.

14. A method of removing water and contaminants from fuel which comprises placing a water and solids contaminants barrier between a filler opening of a fuel tank and the storage space of the fuel tank so that the fuel entering the tank through the filler opening passes through the barrier before reaching said storage space.

15. A method of filling a fuel tank which has a fuel inlet, a fuel storage space and a fuel outlet from said space connected by a fuel feed pipe to the fuel injection system of an engine, the method comprising feeding the fuel into said storage space of the tank through a water and contaminant removing barrier which is between said fuel inlet and said storage space.
